(19) United States
(12) Patent Application Publication
(10) Pub. No.: US 2023/0178752 A1
(43) Pub. Date: Jun. 8, 2023

(54) ALL-SOLID-STATE BATTERY WITH INTERMEDIATE LAYER CONTAINING METAL SULFIDE

(71) Applicants: HYUNDAI MOTOR COMPANY, Seoul (KR); KIA CORPORATION, Seoul (KR)

(72) Inventors: Seung Ho Choi, Hanam-si (KR); Ga Hyeon Im, Hwaseong-si (KR); Sang Heon Lee, Yongin-si (KR); Yun Sung Kim, Seoul (KR)

(73) Assignees: Hyundai Motor Company, Seoul (KR); Kia Corporation, Seoul (KR)

(21) Appl. No.: 18/071,009

(22) Filed: Nov. 29, 2022

(30) Foreign Application Priority Data
Dec. 3, 2021 (KR) 10-2021-0171465

(51) Int. Cl. H01M 4/62; H01M 4/66; H01M 4/38

(52) U.S. Cl. CPC H01M 4/628; H01M 4/661; H01M 4/382; H01M 2004/021

(57) ABSTRACT

An all-solid-state battery is provided with an intermediate layer containing a metal sulfide.

### CROSS-REFERENCE TO RELATED APPLICATION

The present application claims priority to Korean Patent Application No. 10-2021-0171465 filed on Dec. 3, 2021, the entire contents of which is incorporated herein for all purposes by this reference.

### BACKGROUND OF THE PRESENT DISCLOSURE

### Field of the Present Disclosure

The present disclosure relates to an all-solid-state battery provided with an intermediate layer including a metal sulfide.

### Description of Related Art

The energy density of a lithium secondary battery is determined depending on the composition of cathode and anode materials. Recently, an anode free all-solid-state battery has been proposed in order to greatly improve the energy density.

As the term implies, an anode free all-solid-state battery does not use an anode active material capable of storing lithium ions. During charging, lithium ions move from the cathode to the anode and are converted into lithium metal through a reduction reaction with electrons on the surface of the anode current collector. During discharging, reverse electrochemical reactions occur. Therefore, charging and discharging are possible even without an anode active material.

In order to improve the lifespan of the anode free all-solid-state battery, it is necessary to uniformly form lithium metal on the surface of the anode current collector. Anode current collectors that are currently being used generally have low reactivity with lithium ions since they do not have reactivity with electrolytes. That is, most anode current collectors do not electrochemically react with lithium ions and are lithiophobic. Therefore, the development of an anode current collector with lithium affinity is essential for improving the performance of an anode free all-solid-state battery.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an all-solid-state battery in which lithium metal is uniformly formed on an anode current collector.

The object of the present disclosure is not limited to the object mentioned above. The object of the present disclosure will become clearer from the following description, and will be realized by means and combinations thereof described in the claims.

An all-solid-state battery according to an exemplary embodiment of the present disclosure may comprise: an anode current collector; an intermediate layer disposed on the anode current collector; a solid electrolyte layer disposed on the intermediate layer; a cathode active material layer disposed on the solid electrolyte layer; and a cathode current collector disposed on the cathode active material layer, wherein the intermediate layer may include a metal sulfide represented by Chemical Formula 1:

MₓS_{y} [Chemical Formula 1]

wherein M may include at least one of In, Sn, Bi, Pb, Si, Ge, Pb, Sb, Zn, or any combination thereof, and 1≤x≤2 and 0.5≤y≤3 may be satisfied.

The anode current collector may include at least one of Ni, Cu, stainless steel (SUS), or any combination thereof.

The metal sulfide may include at least one of In₂S₃, SnS, Bi₂S, FeS, or any combination thereof.

The intermediate layer may have a thickness of about 100 nm to 1,000 nm.

The intermediate layer may have an initial capacity of about 1.0 mAh/cm² or less than 1.0 mAh/cm².

The all-solid-state battery may further comprise a lithium layer between the anode current collector and the intermediate layer, and the lithium layer may include at least lithium metal.

The lithium layer may further include at least one of lithium sulfide, an alloy of lithium and a metal derived from the metal sulfide, or any combination thereof.

The all-solid-state battery according to an exemplary embodiment of the present disclosure are very excellent in the lifespan, capacity retention rate, and the like since lithium metal is uniformly formed on the anode current collector.

The all-solid-state battery according to an exemplary embodiment of the present disclosure has a very high energy density per weight and volume.

The all-solid-state battery according to an exemplary embodiment of the present disclosure contains a lithium alloy, lithium sulfide, and the like in the lithium layer formed during charging, and since the above materials can electrochemically react with lithium ions even at room temperature, operation at room temperature is possible.

The effects of the present disclosure are not limited to the above-mentioned effects. It should be understood that the effects of the present disclosure include all effects that can be inferred from the following description.

### BRIEF DESCRIPTION OF THE DRAWINGS

FIG. 1 shows an all-solid-state battery according to an exemplary embodiment of the present disclosure.

FIG. 2 shows a state in which the all-solid-state battery according to an exemplary embodiment of the present disclosure is charged.

FIG. 3 shows an anode current collector on which an intermediate layer prepared in Preparation Example 1 is deposited.

FIG. 4 shows an anode current collector on which an intermediate layer prepared in Comparative Preparation Example 1 is deposited.

FIG. 5 is results of analyzing the anode current collector on which the intermediate layer prepared in Preparation Example 1 is deposited by scanning electron microscopy with energy dispersive spectroscopy (SEM-EDS).

FIG. 6 is results of evaluating the lifespans of half-cells according to Example 1 and Comparative Example 1.

FIG. 7 is results of the first and second charge-discharge cycles of the half-cell according to Example 1.

FIG. 8 is a result of measuring the capacity retention rate of a full-cell according to Example 2.

FIG. 9 is a result of analyzing the cross-sections of an anode current collector and a lithium layer with a scanning electron microscope (SEM) when the full-cell of Example 2 is first charged.

FIG. 10A shows an anode current collector on which the intermediate layer prepared in Preparation Example 2 is deposited.

FIG. 10B shows an anode current collector on which the intermediate layer prepared in Preparation Example 3 is deposited.

FIG. 10C shows an anode current collector on which the intermediate layer prepared in Comparative Preparation Example 2 is deposited.

FIG. 11A is results of analyzing the anode current collector on which the intermediate layer prepared in Preparation Example 2 is deposited by SEM-EDS.

FIG. 11B is results of analyzing the anode current collector on which the intermediate layer prepared in Preparation Example 3 is deposited by SEM-EDS.

FIG. 11C is results of analyzing the anode current collector on which the intermediate layer prepared in Comparative Preparation Example 2 is deposited by SEM-EDS.

FIG. 12A is a result of charging and discharging a half-cell according to Example 3.

FIG. 12B is a result of charging and discharging a half-cell according to Example 4.

FIG. 12C is a result of charging and discharging a half-cell according to Comparative Example 2.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

The above objects, other objects, features and advantages of the present disclosure will be easily understood through the following exemplary embodiments related to the accompanying drawings. However, the present disclosure is not limited to the embodiments described herein and may be embodied in other forms. Rather, the embodiments introduced herein are provided so that the disclosed content may become thorough and complete, and the spirit of the present disclosure may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present disclosure. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present disclosure. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Furthermore, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Furthermore, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated.

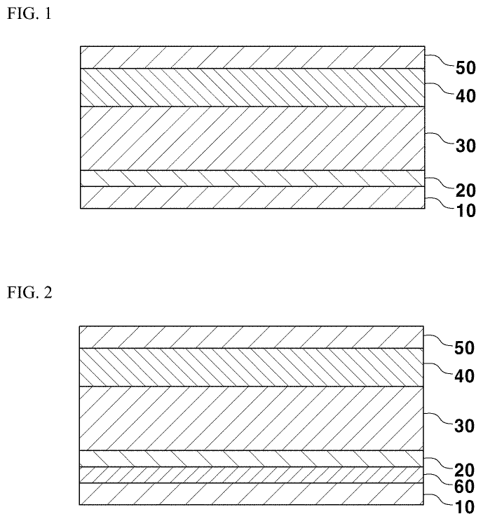

FIG. 1 shows an all-solid-state battery according to an exemplary embodiment of the present disclosure. Referring to this, the all-solid-state battery may be one in which an anode current collector 10, an intermediate layer 20, a solid electrolyte layer 30, a cathode active material layer 40, and a cathode current collector 50 are laminated.

The anode current collector 10 may be an electrically conductive plate-shaped substrate. Specifically, the anode current collector 10 may be in the form of a sheet, a thin film, or a foil.

The anode current collector 10 may include a material that does not react with lithium. Specifically, the anode current collector 10 may include at least one selected from the group consisting of Ni, Cu, stainless steel (SUS), and combinations thereof.

The intermediate layer 20 may include a metal sulfide represented by Chemical Formula 1:

MₓS_{y} [Chemical Formula 1]

wherein M is a metal capable of forming an alloy with lithium, and may specifically include at least one selected from the group consisting of In, Sn, Bi, Pb, Si, Ge, Pb, Sb, Zn, and combinations thereof.

In Chemical Formula 1 above, x and y may satisfy 1≤x≤2 and 0.5≤y≤3.

The metal sulfide may include at least one selected from the group consisting of In₂S₃, SnS, Bi₂S, FeS, and combinations thereof.

The metal sulfide (MₓS_{y}) is one in which a metal cation (M⁺) and a sulfur ion (S⁻) are bonded. The metal sulfide is converted by reacting with lithium ions as shown in Reaction Formula 1 below.

MₓS_{y}+2yLi⁺→xM+y(Li₂S) [Reaction Formula 1]

The metal (M) formed through the above Reaction Formula 1 reacts with lithium ions as shown in Reaction Formula 2 below to form an alloy.

M+aLi⁺→M-Liₐ(a=a number belonging to 1 to 4.4) [Reaction Formula 2]

In Reaction Formula 2, a slash (—) indicates that the metal (M) and lithium metal are alloyed.

When a lithium anode is used as a reference electrode, the theoretical voltage at which lithium ions react with electrons and are precipitated as lithium metal is 0 V. The metals have a theoretical voltage of 0.01 V to 2.0 V when a lithium anode is used as a reference electrode. That is, a reaction in which lithium ions meet the metals to form an alloy is more dominant than a reaction in which lithium ions meet electrons and are converted into lithium metal. Therefore, during charging, the electrochemical reaction between lithium ions and metal in the intermediate layer 20 containing the metal occurs preferentially over the precipitation reaction of lithium ions into lithium metal. Then, the M-Liₐ alloy is sufficiently formed during the charging process, and this phenomenon has the effect capable of uniformly spreading lithium ions into the intermediate layer 20. If the intermediate layer 20 is not present, a site where lithium ions can react is only a two-dimensional planar current collector. Even in the current collector, the reaction does not occur simultaneously, but electrons are concentrated in a bent or bonded part so that the lithium metal grows locally.

Furthermore, the M-Liₐ alloy is very friendly with lithium ions. Since the M-Liₐ alloy formed during the charging process is in an excessive state of lithium, the energy at which lithium is deposited can be lowered. That is, the metal present in the intermediate layer 20 preferentially reacts with lithium ions at a voltage higher than the lithium precipitation voltage. Therefore, lithium ions may be uniformly three-dimensionally distributed inside the intermediate layer 20.

That is, since the metal sulfide has reactivity with lithium ions and is lithiophilic, it can be used as a lithium-inducing material.

Meanwhile, during charging, the metal sulfide is converted into the metal and lithium sulfide (Li₂S) through a reduction reaction as shown in Reaction Formula 1 above. Since the lithium sulfide suppresses aggregation of metal during repeated charging and discharging processes, higher cycle stability can be secured compared to when a forgeable metal is used as the material for the intermediate layer 20.

FIG. 2 shows a state in which the all-solid-state battery according to an exemplary embodiment of the present disclosure is charged. Referring to this, the all-solid-state battery may comprise a lithium layer 60 between the anode current collector 10 and the intermediate layer 20.

In the all-solid-state battery, lithium ions move to the intermediate layer 20 through the solid electrolyte layer 30 at the initial stage of charging. The lithium ions move toward the anode current collector 10 through the metal nitride, and in this process, they react with a metal M to form an M-Liₐ alloy between the anode current collector 10 and the intermediate layer 20. When charging is continued, lithium is uniformly deposited or precipitated around the M-Liₐ alloy to form a lithium layer 60. The lithium layer 60 may include at least lithium metal. Furthermore, the lithium layer 60 may further include at least one selected from the group consisting of an M-Liₐ alloy and lithium sulfide (Li₂S) as products of Reaction Formulas 1 and 2 above, and combinations thereof.

When an all-solid-state battery is discharged, reverse reactions of those described above occurs. That is, the all-solid-state battery can be reversibly charged and discharged.

The intermediate layer 20 may have a thickness of 100 nm to 1,000 nm. When the intermediate layer 20 has a thickness of less than 100 nm, it may be difficult for the intermediate layer 20 to form a uniform interface with the solid electrolyte layer 30. When the intermediate layer 20 has a thickness of exceeding 1,000 nm, the energy density may be lowered.

The intermediate layer 20 may be one which has an initial capacity reacting with lithium of 1.0 mAh/cm² or less. The initial capacity of the intermediate layer means an amount of irreversible Li′ required to form a metal-lithium alloy and Li₂S. The lower the corresponding capacity, the higher the reversible capacity can be expected when manufacturing a full-cell. However, the initial capacity of the intermediate layer 20 may be appropriately adjusted depending on the thickness of the intermediate layer 20, the capacity of the cathode active material layer 40, and the like. For example, the initial capacity of the intermediate layer 20 may be 10% or less of the initial capacity of the cathode active material layer 40.

A method for preparing the intermediate layer 20 is not particularly limited. However, it may be preferable to prepare the intermediate layer 20 by a deposition method in order to prepare the intermediate layer 20 to a thickness of 1,000 nm or less. The deposition method is not particularly limited, and may be chemical vapor deposition (CVD) such as thermal CVD, plasma enhanced CVD, atmospheric pressure CVD, or low pressure CVD, or physical vapor deposition (PVD) such as electron beam evaporation or sputtering. The intermediate layer 20 may be deposited on the anode current collector 10 by electron beam evaporation.

The solid electrolyte layer 30 interposed between the cathode active material layer 40 and the anode current collector 10 transfers lithium ions.

The solid electrolyte layer 30 may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. However, it may be preferable to use a sulfide-based solid electrolyte having high lithium ion conductivity. The sulfide-based solid electrolyte is not particularly limited, but may be Li₂S—P₂S₅, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S-Sis₂-LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, or the like.

The oxide-based solid electrolyte may include perovskite-type Li₃ₓLa_{2/3-x}TiO₃ (LLTO), phosphate-based NASICON type Li₁₊ₓAlₓTi₂₋ₓ(PO₄)₃ (LATP), and the like.

The polymer electrolyte may include a gel polymer electrolyte, a solid polymer electrolyte, and the like.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode active material layer 40 reversibly occludes and releases lithium ions. The cathode active material layer 40 may include a cathode active material, a solid electrolyte, a conductive material, a binder, and the like.

The cathode active material may include an oxide active material or a sulfide active material.

The oxide active material may include a rock salt layer-type active material such as LiCoO₂, LiMnO₂, LiNiO₂, LiVO₂, Li₁₊ₓNi_{1/3}Co_{1/3}Mn_{1/3}O₂, or the like, a spinel-type active material such as LiMn₂O₄, Li(Ni_{0.5}Mn_{1.5})O₄, or the like, a reverse spinel-type active material such as LiNiVO₄, LiCoVO₄, or the like, an olivine-type active material such as LiFePO₄, LiMnPO₄, LiCoPO₄, LiNiPO₄, or the like, a silicon-containing active material such as Li₂FeSiO₄, Li₂MnSiO₄, or the like, a rock salt layer-type active material in which a part of the transition metal is substituted with a dissimilar metal, such as LiNi_{0.8}Co_{(0.2-x)}AlₓO₂ (0<x<0.2), a spinel-type active material in which a part of the transition metal is substituted with a dissimilar metal, such as Li₁₊ₓMn_{2-x-y}M_{y}O₄ (M is at least one of Al, Mg, Co, Fe, Ni, and Zn, and 0<x+y<2), and a lithium titanate such as Li₄Ti₅O₁₂ or the like.

The sulfide active material may include copper chevrel, iron sulfide, cobalt sulfide, nickel sulfide, or the like.

The solid electrolyte may include at least one selected from the group consisting of an oxide-based solid electrolyte, a sulfide-based solid electrolyte, a polymer electrolyte, and combinations thereof. However, it may be preferable to use a sulfide-based solid electrolyte having high lithium ion conductivity. The sulfide-based solid electrolyte is not particularly limited, but may be Li₂S—P₂S₅, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂-LiₓMO_{y} (provided that x and y are positive numbers, and M is one of P, Si, Ge, B, Al, Ga, and In), Li₁₀GeP₂S₁₂, or the like.

The oxide-based solid electrolyte may include perovskite-type Li₃ₓLa_{2/3-x}TiO₃ (LLTO), phosphate-based NASICON type Li₁₊ₓAlₓTi₂₋ₓ(PO₄)₃ (LATP), and the like.

The polymer electrolyte may include a gel polymer electrolyte, a solid polymer electrolyte, and the like.

The conductive material may include carbon black, conductive graphite, ethylene black, carbon fiber, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode current collector 50 may be a plate-shaped substrate having electrical conductivity. Specifically, the cathode current collector 50 may be in the form of a sheet or a thin film.

The cathode current collector 50 may include at least one selected from the group consisting of indium, copper, magnesium, aluminum, stainless steel, iron, and combinations thereof.

Hereinafter, another forms of the present disclosure will be described in more detail through Examples. The following Examples are merely illustrative to help the understanding of the present disclosure, and the scope of the present disclosure is not limited thereto.

Hereinafter, the conditions of the intermediate layers of Preparation Examples 1 to 3, Comparative Preparation Example 1, and Comparative Preparation Example 2 to be described later in Table 1 are summarized.

TABLE 1

| Classification | Type of metal sulfide | Thickness |
|---|---|---|
| Preparation Example 1 | In₂S₃ | 500 nm |
| Preparation Example 2 | SnS | 500 nm |
| Preparation Example 3 | Bi₂S₃ | 500 nm |
| Comparative Preparation Example 1 | In₂S₃ | 50 nm |
| Comparative Preparation Example 2 | FeS | 100 nm |

### Preparation Example 1

Stainless steel (SUS) with a thickness of about 10 μm was provided as an anode current collector. An intermediate layer including In₂S₃, a metal sulfide, and having a thickness of about 500 nm was deposited on the anode current collector through electron beam evaporation.

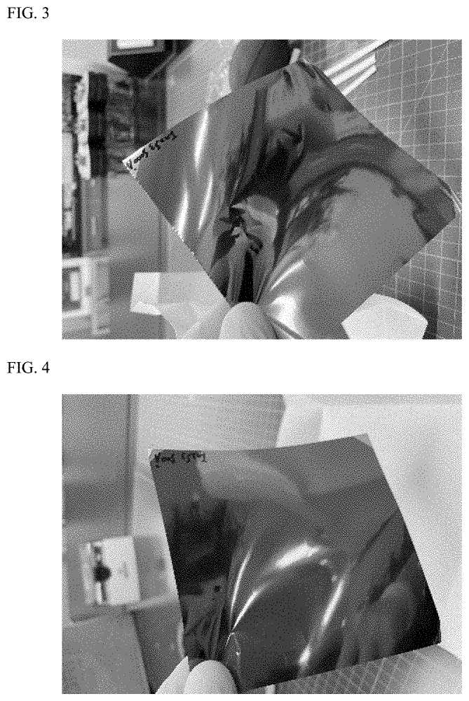

FIG. 3 shows the anode current collector on which an intermediate layer prepared in Preparation Example 1 is deposited. It can be confirmed that the intermediate layer is very uniformly deposited on the anode current collector.

FIG. 5 is results of analyzing the anode current collector on which the intermediate layer prepared in Preparation Example 1 is deposited by scanning electron microscopy with energy dispersive spectroscopy (SEM-EDS). Referring to this, it can be seen that indium (In) and sulfur (S) are very uniformly distributed.

### Comparative Preparation Example 1

An intermediate layer was formed in the same manner as in Preparation Example 1 above except that the thickness of the intermediate layer was adjusted to about 50 nm. FIG. 4 shows the anode current collector on which an intermediate layer prepared in Comparative Preparation Example 1 is deposited. When judged by the naked eye, the intermediate layer of Comparative Preparation Example 1 was also well deposited without gaps.

### Example 1 and Comparative Example 1

Half-cells in which anode current collectors having the intermediate layers of Preparation Example 1 and Comparative Preparation Example 1 deposited thereon, solid electrolyte layers, and lithium foils were laminated were respectively prepared. The solid electrolyte layer was prepared by pressurizing a solid electrolyte powder to about 100 MPa, and the anode current collectors having the intermediate layers prepared in the Preparation Example 1 and Comparative Preparation Example 1 deposited thereon were attached onto the solid electrolyte layer so that one surfaces of the intermediate layer and the solid electrolyte layer are in contact. The resultant product was pressurized at about 500 MPa for about 1 minute. The half-cell was manufactured by putting the lithium foil on the other surface of the solid electrolyte layer and tightening it at about 30 MPa.

Example 1 is a half-cell using the anode current collector of Preparation Example 1, and Comparative Example 1 is a half-cell using the anode current collector of Comparative Preparation Example 1.

While charging and discharging each half-cell according to Example 1 and Comparative Example 1 at a current density and a deposition capacity of about 1.17 mA/cm² and 3.52 mAh/cm², the lifespan, capacity, and the like were measured. The evaluation temperature was about 60° C., and the evaluation pressure was about 30 MPa.

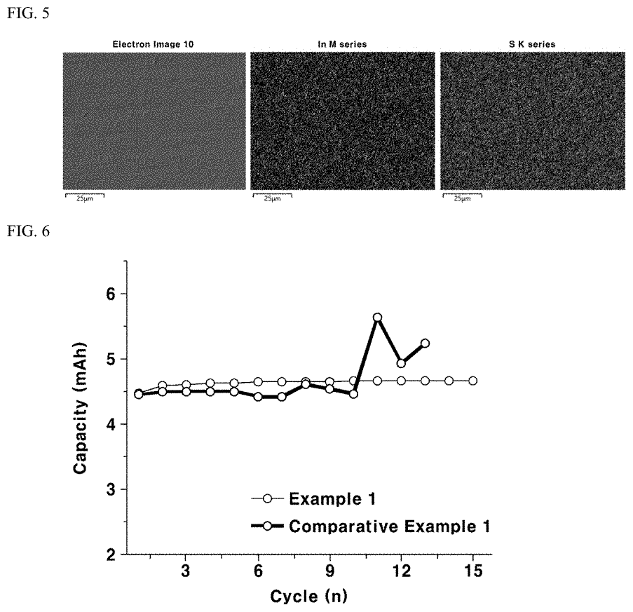

FIG. 6 is results of evaluating the lifespans of the half-cells according to Example 1 and Comparative Example 1. Referring to this, the half-cell according to Example 1 was stably driven for 15 cycles, whereas a short circuit occurred within about 10 cycles of the half-cell according to Comparative Example 1. This is because the intermediate layer in Comparative Example 1 was too thin to form a uniform interface between the solid electrolyte layer and the intermediate layer.

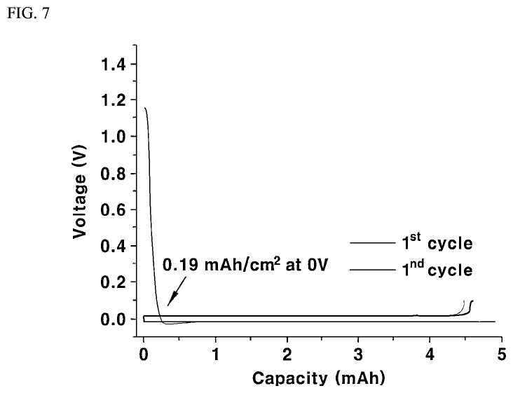

FIG. 7 is results of the first and second charge-discharge cycles of the half-cell according to Example 1. At OCV, an initial capacity of 0.19 mAh/cm² was shown until it reached 0 V, which is an irreversible capacity required for the conversion reaction of metal sulfides. After the initial reaction, no further conversion reaction occurred from the second cycle. That is, it means that all metal sulfides deposited in the first cycle participated in the electrochemical conversion reaction.

### Example 2

A full-cell in which an anode current collector having the intermediate layer of Preparation Example 1 deposited thereon, a solid electrolyte layer, and a cathode active material layer were laminated was prepared. In the same manner as in Example 1, a structure in which an anode current collector, an intermediate layer, and a solid electrolyte layer were laminated was prepared, and a cathode active material layer including LiNi_{0.8}Co_{0.1}Mn_{0.1}O₂ as a cathode active material was formed on the solid electrolyte layer.

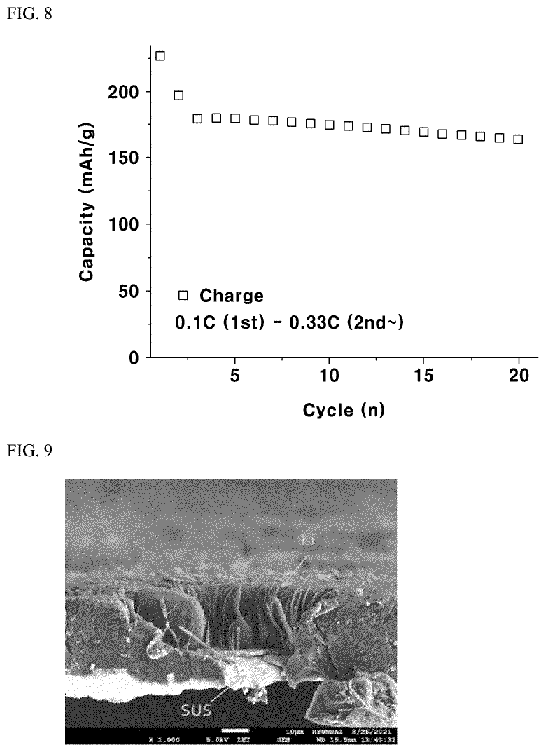

The full-cell of Example 2 was driven at 0.1 C for the first cycle, and then its lifespan was evaluated while driving it at 0.33 C. FIG. 8 is a result of measuring the capacity retention rate of the full-cell according to Example 2. Referring to this, the full-cell had a first charge capacity of 226.6 mAh/g at 0.1 C, and showed a reversible capacity of about 163.9 mAh/g without a short circuit being occurred even after 20 cycles. Through this, it can be seen that the cycle stability of the battery can be greatly improved when using the anode current collector having the intermediate layer formed thereon according to an exemplary embodiment of the present disclosure.

FIG. 9 is a result of analyzing the cross-sections of an anode current collector and a lithium layer with a scanning electron microscope (SEM) when the full-cell of Example 2 is first charged. Referring to this, it can be seen that lithium metal (Li) is grown to a uniform height on the anode current collector. That is, it can be seen that lithium ions were uniformly deposited into lithium metal through a uniform conversion reaction of the metal sulfide of the intermediate layer.

### Preparation Example 2, Preparation Example 3, and Comparative Preparation Example 2

Anode current collectors having intermediate layers deposited thereon were prepared in the same manner as in Preparation Example 1 except that the metal sulfide was changed to SnS (Preparation Example 2), Bi₂S₃ (Preparation Example 3), and FeS (Comparative Preparation Example 2) respectively. However, the thickness of the intermediate layer was adjusted to 100 nm in Comparative Preparation Example 2.

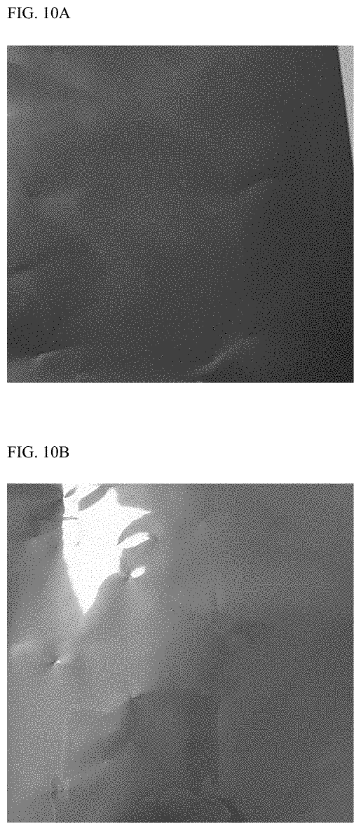

FIG. 10A shows the anode current collector on which the intermediate layer prepared in Preparation Example 2 is deposited. FIG. 10B shows the anode current collector on which the intermediate layer prepared in Preparation Example 3 is deposited. FIG. 10C shows the anode current collector on which the intermediate layer prepared in Comparative Preparation Example 2 is deposited. It can be seen that the intermediate layers were uniformly formed when they are judged with the naked eye in all of Preparation Example 2, Preparation Example 3, and Comparative Preparation Example 2.

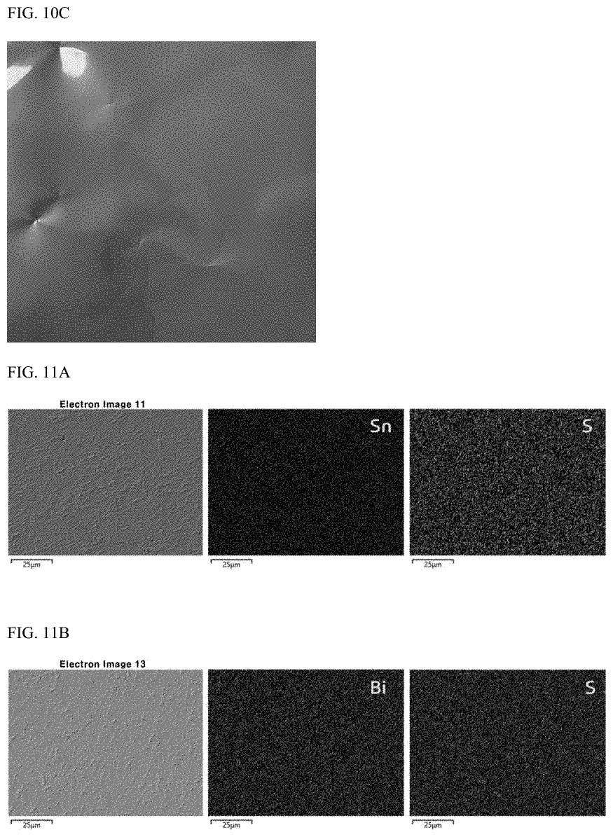

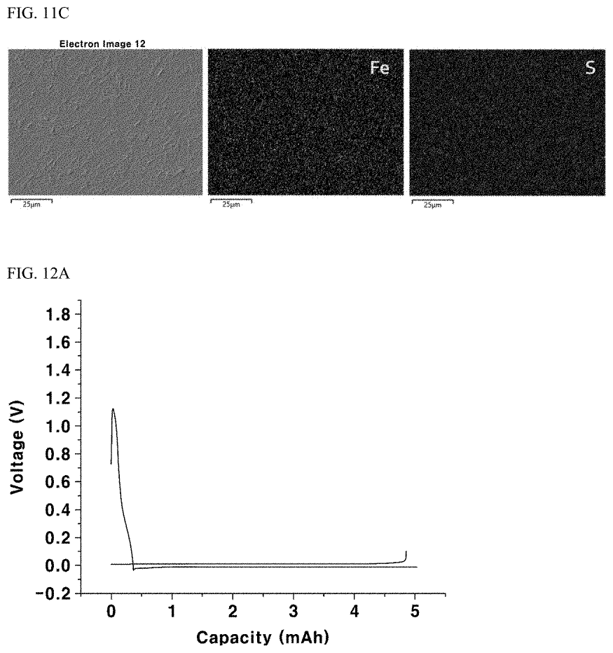

FIG. 11A is results of analyzing the anode current collector on which the intermediate layer prepared in Preparation Example 2 is deposited by SEM-EDS. Referring to this, it can be seen that tin (Sn) and sulfur (S) are very uniformly distributed.

FIG. 11B is results of analyzing the anode current collector on which the intermediate layer prepared in Preparation Example 3 is deposited by SEM-EDS. Referring to this, it can be seen that bismuth (Bi) and sulfur (S) are very uniformly distributed.

FIG. 11C is results of analyzing the anode current collector on which the intermediate layer prepared in Comparative Preparation Example 2 is deposited by SEM-EDS. Referring to this, it can be seen that iron (Fe) and sulfur (S) are very uniformly distributed.

### Example 3, Example 4, and Comparative Example 2

Half-cells were manufactured in the same manner as in Example 1 using the anode current collectors on which the intermediate layers of Preparation Example 2, Preparation Example 3, and Comparative Preparation Example 2 were deposited.

Example 3 is a half-cell using the anode current collector of Preparation Example 2, Example 4 is a half-cell using the anode current collector of Preparation Example 3, and Comparative Example 2 is a half-cell using the anode current collector of Comparative Preparation Example 2.

The properties thereof were evaluated while charging and discharging the half-cells according to Examples 3, Example 4, and Comparative Example 2 under the same conditions and method as in Example 1.

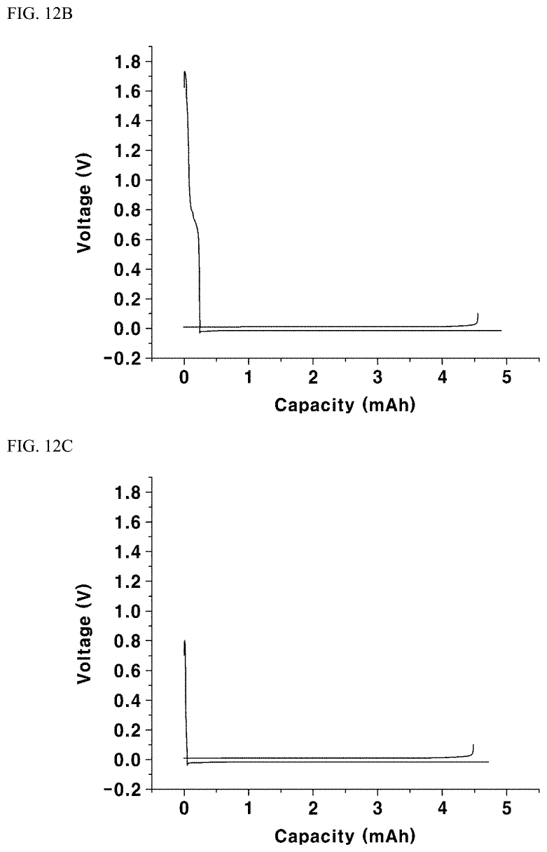

FIG. 12A is a result of charging and discharging the half-cell according to Example 3. When an intermediate layer containing SnS was applied, an initial capacity of 0.36 mAh/cm² was exhibited until it reached 0 V at OCV.

FIG. 12B is a result of charging and discharging the half-cell according to Example 4. When an intermediate layer containing Bi₂S₃ was applied, an initial capacity of 0.24 mAh/cm² was exhibited until it reached 0 V at OCV.

Meanwhile, FIG. 12C is a result of charging and discharging the half-cell according to Comparative Example 2. When an intermediate layer containing FeS was applied, the capacity was not expressed until it reached 0 V at OCV.

Through Examples and Comparative Examples, it can be seen that a difference in decomposition reaction occurs depending on the type of metal sulfide, and when the metal contained in the metal sulfide is In, Sn, Bi, or the like that can be alloyed with lithium, the desired effect can be realized in the present disclosure.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An all-solid-state battery comprising:
an anode current collector;
an intermediate layer disposed on the anode current collector;
a solid electrolyte layer disposed on the intermediate layer;
a cathode active material layer disposed on the solid electrolyte layer; and
a cathode current collector disposed on the cathode active material layer, wherein the intermediate layer comprises a metal sulfide represented by Chemical Formula 1:
MₓS_{y} [Chemical Formula 1]
wherein M comprises at least one of In, Sn, Bi, Pb, Si, Ge, Pb, Sb, Zn, or any combination thereof, and 1≤x≤2 and 0.5≤y≤3 are satisfied.

2. The all-solid-state battery of claim 1, wherein the anode current collector comprises at least one of Ni, Cu, stainless steel (SUS), or any combination thereof.

3. The all-solid-state battery of claim 1, wherein the metal sulfide comprises at least one of In₂S₃, SnS, Bi₂S, FeS, or any combination thereof.

4. The all-solid-state battery of claim 1, wherein the intermediate layer has a thickness of about 100 nm to 1,000 nm.

5. The all-solid-state battery of claim 1, wherein the intermediate layer has an initial capacity of about 1.0 mAh/cm² or less than 1.0 mAh/cm².

6. The all-solid-state battery of claim 1, wherein the all-solid-state battery further comprises a lithium layer between the anode current collector and the intermediate layer, and the lithium layer comprises at least lithium metal.

7. The all-solid-state battery of claim 6, wherein the lithium layer further comprises at least one of lithium sulfide, an alloy of lithium and a metal derived from the metal sulfide, or any combination thereof.
